(19) United States
(12) Patent Application Publication
(10) Pub. No.: US 2025/0219888 A1
(43) Pub. Date: Jul. 3, 2025

(54) MANAGING NETWORK ELEMENTS IN RADIO ACCESS NETWORKS OF TELECOMMUNICATIONS SYSTEMS

(71) Applicant: Telecom Italia S.p.A., Milano (IT)

(72) Inventors: Paolo GORIA, Torino (IT); Francesco MAURO, Torino (IT)

(73) Assignee: Telecom Italia S.p.A., Milano (IT)

(21) Appl. No.: 18/852,516

(22) PCT Filed: Mar. 16, 2023
(86) PCT No.: PCT/EP2023/056806

§ 371 Date: Sep. 30, 2024

(30) Foreign Application Priority Data
Apr. 1, 2022 (IT) 102022000006494

(51) Int. Cl. H04L 41/06

(52) U.S. Cl. CPC H04L 41/06

(57) ABSTRACT

A method of managing Network Elements of a system of access networks of a telecommunications network by one or more telecommunications operators through one or more Network Element management functionalities by Operational Support Systems of the telecommunications operators. The method comprises providing a mediator module configured for mediating the communications between the Operational Support Systems of the telecommunications operators and the Network Element management functionality by filtering the communications according to predetermined filtering criteria for allowing the Operational Support System of each of the one or more telecommunications operators to manage only a respective part of the Network Elements of the access network depending on the filtering criteria.

### TECHNICAL BACKGROUND

### Technical Field

The solution disclosed in this document broadly relates to the field of telecommunications, particularly to wireless (radio) telecommunications systems and networks, such as (cellular) mobile telephony networks. Specifically, the solution disclosed herein relates to the management of Network Elements in Radio Access Networks of, e.g., mobile telephony networks.

### Overview of the Related Art

In radio telecommunications systems, like mobile telephony networks, a Radio Access Network (RAN) is that part of the telecommunications system that implements the radio access of user devices to the telecommunications system, e.g., to the mobile telephony network, by implementing a certain radio access technology. The RAN resides between the user devices (User Equipment—UEs, or terminal equipment, or Mobile Stations—MSs, the name depending on the telecommunications standard), such as mobile phones, and provides connection with the Core Network (CN) of the telecommunications system.

A RAN of a radio telecommunications network comprises several Network Elements (NEs), which are elements deployed at the edge of the telecommunications network for managing the radio transmissions (e.g., NodeBs, eNodeBs, gNodeBs, depending on the generation of the radio telecommunications network) of the network. The NEs need to be managed and monitored by the telecommunications network operator(s) in order to ensure the desired level of Quality of Service (QOS) to the users.

Fault Configuration Accounting Performance and Security (FCAPS) is the ISO Telecommunications Management Network model and framework for the management of telecommunications networks. Fault, configuration, accounting (or, sometimes, administration), performance and security are the management categories into which the ISO model defines the network management tasks.

FCAPS management of NEs in RANs by the telecommunications network operators is usually based on so-called Element Managers (EMs).

An EM is an element of the telecommunications network that is concerned with the management of functions and capabilities of one or, typically, more NEs associated therewith and under its responsibility.

An EM provides (i.e., exposes) two interfaces: a SouthBound Interface (SBI), towards the NEs under its responsibility, and a NorthBound Interface (NBI), i.e., an interface that allows the EM to communicate with higher-level sub-systems of the wireless telecommunications system, particularly an Operational Support System (OSS) that includes for example systems of the telecommunications network operator for Configuration Management (CM), Performance Management (PM), Trace Management (TM) etc. of the NEs. The NBI conceptualizes the lower-level details (e.g., data or functions) used by, or in, the EM, allowing the EM to interface with the OSS.

There are radio telecommunications systems in which the RAN is totally owned and operated by a single network operator. Other radio telecommunications systems have a RAN infrastructure, called Multi-Operator Radio Access Network (MORAN), which is shared by two or more network operators: each one of the network operators own some of the NEs of the RAN and shares them with the other network operators for the purpose of providing services to the respective subscribers.

A network operator who materially owns a NE (e.g., a NodeB, an eNodeB, a gNodeB) is the “host” network operator for that NE. The host network operator may share the owned NE (i.e., for example, its NodeB, its eNodeB, its gNodeB) with other network operators, which are “guest” network operators in respect of that NE. The sharing may include, for example, the hosting of a group of cells on the same NE, with some of such cells belonging to “host” operator and the remaining cells belonging respectively to different “guest” operators.

Typically, in a MORAN scenario NEs owned by different operators are deployed in different geographical areas, i.e., one network operator deploys its NEs in one geographical region, another network operator deploys its NEs in another geographical region, and so on.

EP 2477427 A1 discloses RANs, in particular methods and systems enabling multi-operator charging in a RAN. A radio base station in a radio access network is described, wherein the radio base station is adapted to connect to a plurality of core networks upstream of the radio base station. The radio base station comprises a radio transmission and/or reception unit adapted to establish a communication over a radio interface with a user equipment, and a processing unit adapted to determine a first of the plurality of core networks, wherein the first core network handles the communication with the user equipment upstream of the radio base station; attributes resources to the communication with the user equipment; and tracks an indication of the attributed resources associated with the first core network.

CA 2521224 A1 discloses a method for radio communication in a cellular radio network having a radio access network and a core network, the method comprising connecting at least two different core networks to one RAN, and sharing at least one network element (RNC, BTS) of the RAN between the at least two different core networks. US 2014/0348068 A1 discloses an apparatus that includes core interface means adapted to provide an eastbound interface to a first core network element and to a second core network element different from the first core network element; radio interface means adapted to provide a westbound interface to a first radio access network element and to a second radio access network element different from the first radio access network element; multiplex detecting means adapted to detect if a first request received at one of the eastbound and westbound interfaces is directed to the first and/or the second of the network elements of the respective other interface; adapting means adapted to adapt the first request according to the network element to which it is directed; multiplexing means adapted to multiplex the adapted first request to the first and/or the second of the network elements of the respective other interface according to detection by the multiplex detecting means.

WO 2014/053597 A1 discloses a method in a network node for configuring the network node for a first and at least one second PLMN in a telecommunications system. The network node is adapted to serve one or more cells. The network node configures a primary PLMN information for the one or more cells to comprise neither of the first or the at least one second PLMN. The network node configures further PLMN information for each cell of the one or more cells in the network node based on information indicating to which of the first or at least one second PLMNs each cell belongs to.

EP 3059903 A1 discloses that in order to allow a plurality of Mobile Network Operators (MNOs) to share at least two of RANs, a Mobile Backhaul Network (MBH), and a Core Network (CN), a network control system operates to enforce a network resource configuration to each of the at least two networks to be shared out of the RAN, the MBH, and the CN in accordance with common resource partitioning information indicating slicing of network resources among the plurality of MNOs. It is thus possible to contribute to improving the efficiency of performing setting of network resource allocation on the at least two networks to be shared.

### SUMMARY

The Applicant notices that all the prior-art documents cited above are focused on radio aspects and not on the management of NEs of the RANs, where by “management of NEs of the RANs” it is here meant FCAPS (Fault Configuration Accounting Performance and Security) management of NEs in RANs by the telecommunications network operators based on Element Managers (EMs) and their functionalities, as defined in the ISO Telecommunications Management Network model and framework for the management of telecommunications networks, or any equivalent management system for the management of NEs with functionalities equivalent to those of FCAPS.

In particular, all the prior-art documents mentioned in the foregoing relate to RAN sharing only from a radio resources allocation and apparatus point of view. None of the cited documents focuses on NEs' management, not to say on FCAPS.

In addition, the cited prior-art documents do not cover the management of NEs of the RANs in scenarios like MORANs and Private Networks. MORAN, as explained in the foregoing, refers to a scenario in which a RAN infrastructure of a radio telecommunications system is shared by two or more network operators, each one of the network operators (host network operators) owning some of the NEs (e.g., NodeBs, eNodeBs, gNodeBs) of the RAN and sharing them with (at least one of) the other network operators (which are guest network operators in respect of the NEs owned by the host network operator). A Private Network (also referred to as “non-public network”) is a private cellular network that uses cellular mobile telephony network technologies, particularly licensed, shared, or unlicensed wireless spectrum and 4G or 5G cellular networking base stations, small cells, and other parts of the 4G or 5G RAN infrastructure to transmit voice and data to edge devices, including smart phones, embedded modules, routers, and gateways. The difference between a public and a Private Network resides in who has a license or priority access to the wireless spectrum, and who owns and operates the network's base stations and infrastructure: with public networks, the telecommunications network operator owns and operates the spectrum and the network infrastructure, and generally all of the subscribers to the telecommunications network operator have the same access rights to the network. On the contrary, in Private Networks private organizations own, operate, or have some level of priority access to the network's infrastructure or spectrum.

The solution disclosed in this document relates to the management of Network Elements (NEs) in Radio Access Networks (RANs) of radio telecommunications networks. As explained a few lines above, by “management of NEs in RANs” it is here meant FCAPS (Fault Configuration Accounting Performance and Security) management of NEs in RANs by the telecommunications network operators, as defined in the ISO Telecommunications Management Network model and framework for the management of telecommunications networks, or any equivalent management system for the management of NEs with functionalities equivalent to those of FCAPS, based on Element Managers (EMs) and their functionalities.

The Applicant has realized that the EMs, allowing the access by an OSS to the NEs, could be used for implementing RAN “segregation” schemes, for creating partitions of the RAN of a radio telecommunications network. However, the Applicant has noticed that current implementations of EMs are able to allow only simple “partitions” of the RAN (for example partitions only related to 5G nodes for specific manufacturer, because 5G is still a new technology), which make it impossible to manage complex RAN “segregation” schemes, as would be needed in certain use cases such as MORAN and Private Network, causing also security and privacy problems.

In addition, the function and capabilities of the EMs available on the market depend on the specific manufacturer thereof, and an analysis of the products available on the market showed the lack of programmable RAN segregation mechanisms. Due to this, telecommunications network operators are not allowed to define customized RAN segmentation schemes using the mechanisms implemented within the EMs, but only simple segmentations are possible, for example segregation of clusters composed by node/NE and not segregation on per network cell basis.

The Applicant has tackled the problem of offering to telecommunications network operators enhanced capabilities for the management of NEs of their RANs, particularly, but not limitatively, in MORAN and Private Network scenarios. In such scenarios, it is desired to exploit management of the NEs (FCAPS management, as defined in the ISO Telecommunications Management Network model and framework for the management of telecommunications networks, or any equivalent management system for the management of NEs with functionalities equivalent to those of FCAPS) separately for each one of the different network operators, and thus a fine segregation not only at the NE level but even on, e.g., a per network cell basis within the same NE is needed (as known, a NE can manage the radio transmissions in more than one, possibly several network cells; different network cells afferent to a same NE may belong to different network operators: the host network operator and one or more guest network operators, which should be enabled to manage their controlled network cells). Indeed, the Applicant has devised a solution that offers the capability of defining customized RAN segmentation schemes, also inside the same NE, for example by defining proper filtering criteria, for the management of NEs based on Element Managers (EMs) and their functionalities, or based on equivalent functionalities implemented by elements different from EMs, e.g., by distributed micro-services, for example distributed among the NEs and the OSSs of the network operators.

According to an aspect, the solution disclosed herein provides a method of managing Network Elements of a system of access networks of a telecommunications network by one or more telecommunications operators through one or more Network Element management functionalities by Operational Support Systems of the telecommunications operators.

A generic Network Element of the system of access networks (e.g., a NodeB, an eNodeB, a gNodeB) is owned by a telecommunications operator: the host network operator or host operator of that Network Element, and the host operator may share its NE with at least one other telecommunications operator, this latter being a guest network operator or guest operator in respect of that NE.

The method comprises providing a mediator module configured for mediating the communications between the Operational Support Systems of the telecommunications operators and the Network Element management functionality by filtering said communications according to predetermined filtering criteria for allowing the Operational Support System of each of the one or more telecommunications operators to manage only a respective part of the Network Elements of the access network depending on the filtering criteria.

In particular, the communications between the Operational Support Systems of the telecommunications operators and the Network Element management functionality may be intended for Fault Configuration Accounting Performance and Security, FCAPS, management operations on said Network Elements, as defined in the ISO Telecommunications Management Network model and framework for the management of telecommunications networks, or any equivalent management system for the management of NEs with functionalities equivalent to those of FCAPS.

In embodiments, said Network Element management functionalities may be implemented by Element Managers.

Particularly, the Element Managers expose a NorthBound interface and, in embodiments, the mediator module may be interposed between the NorthBound interface of the Element Managers and the Operational Support Systems of the telecommunications operators.

In other embodiments, the Network Element management functionalities may be implemented by distributed partial services distributed among the Network Elements and the Operational Support Systems of the telecommunications operators, said distributed partial services altogether implementing the Network Element management functionalities.

According to another aspect, the solution disclosed herein provides a communications mediator designed to be interposed between a Network Element management functionality, responsible for the management of respective Network Elements of an access network system of a telecommunications system, and at least one Operational Support System of the at least one telecommunications operator of said telecommunications system.

The communications mediator is configured to mediate the communications between the Operational Support System and the Network Element management functionality by filtering said communications according to predetermined filtering criteria for allowing the Operational Support System to manage only a respective part of the Network Elements of the access network depending on said filtering criteria.

The communications between the Operational Support Systems of the telecommunications operators and the Network Element management functionality may be intended for Fault Configuration Accounting Performance and Security, FCAPS, management operations on said Network Elements.

In embodiments, the Network Element management functionalities may be implemented by Element Managers.

The Element Managers expose a NorthBound interface and the mediator module may be interposed between the NorthBound interface of the Element Managers and the Operational Support Systems of the telecommunications operators.

In other embodiments the Network Element management functionalities may be implemented by distributed partial services distributed among the Network Elements and the Operational Support Systems of the telecommunications operators, said distributed partial services altogether implementing the Network Element management functionalities.

The communications mediator may comprise:
a communications filtering module configured to filter said communications between the Operational Support System and the Network Element management functionality according to said predetermined filtering criteria, and
a programming interface configured to receive filtering parameters, defining said predetermined filtering criteria, for configuring said communications filtering module.

According to still another aspect, the solution disclosed herein provides a telecommunications system comprising an access network system which comprises a plurality of Network Elements.

One or more Network Element management functionalities are each one responsible for the management of a respective group of Network Elements of said plurality.

The telecommunications system comprises at least one Operational Support Systems of a respective at least one telecommunications operator.

A communications mediator is provided. The communications mediator is interposed between the Network Element management functionalities and the at least one Operational Support System of the at least one telecommunications operator, and it is configured to mediate the communications between the Operational Support System and the Network Element management functionalities by filtering said communications according to predetermined filtering criteria for allowing the Operational Support System to manage only a respective part of the Network Elements of the access network depending on said filtering criteria.

### BRIEF DESCRIPTION OF THE DRAWINGS

Features and advantages set forth in the foregoing, as well as other features and other advantages, will be made apparent by the following detailed descriptions of the solution here disclosed, provided merely by way of non-limiting examples. For a better intelligibility, the following description should be read in conjunction with the attached drawings, wherein:

FIG. 1 schematically depicts a part of a system of RANs of a wireless mobile telecommunications network, with a NBI mediator according to an embodiment of the solution disclosed herein, and

FIG. 2 depicts in greater detail the NBI mediator shown in FIG. 1, in an embodiment of the solution disclosed herein.

### DETAILED DESCRIPTION OF EXEMPLARY EMBODIMENTS

The solution here disclosed is an advanced mediator module for the North Bound Interface—NBI—of Element Managers—EMs—(in the following also referred to, shortly, as advanced mediator for NBI, or advanced mediator, or NBI mediator, or, simply, mediator) that allows the segregation of a complex Radio Access Network (RAN) or system of RANs of a radio telecommunications system in different RAN partitions, giving to the network operator or operators the possibility to manage separately each RAN partition.

The advanced mediator, interposed between the EMs (with which the advanced mediator interacts via the EMs' NBIs) and one or more Operational Support Systems (OSSs), is configured to expose to the OSSs a different, “filtered” NBI for each desired RAN partition.

For example, considering a Multi-Operator RAN (MORAN) scenario with, e.g., two telecommunications network operators A and B sharing, for the purpose of providing services to their respective subscribers, Network Elements (EMs) of a RAN or a system of RANs, the NEs shared by operator A and operator B may be connected to a same EM. With the advanced mediator for NBI, each network operator can have private access, for FCAPS management purposes, to its own NEs by means of a dedicated, filtered NBI. The overall NBI exposed by the EMs that are responsible of the shared NEs is filtered by the advanced mediator for NBI (in this example, using as a filtering parameter univocal identifiers of the Public Land Mobile Networks—PLMNs—of operator A and operator B) and exposed to the proper network operator that owns, and thus shall have private FCAPS management authorization of, the NEs.

In another exemplary scenario, the advanced mediator can split the data of the overall NBI among different Radio Access Technologies (RATs), different radio frequencies, etc., in order to serve any need of data segregation. In this way, the OSS of a telecommunications network operator is allowed to separately manage (for FCAPS management purposes) NEs of the RAN according to their respective RATs, radio frequencies etc.

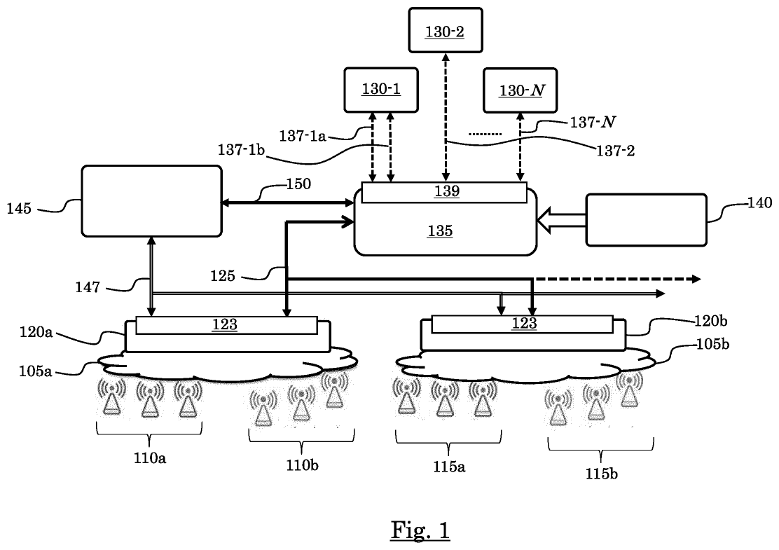

Looking at FIG. 1, a part of a system of RANs of an exemplary wireless mobile telecommunications network is schematically depicted, with a NBI mediato according to an embodiment of the solution disclosed herein.

The exemplary system of RANs shown in FIG. 1 comprises a first RAN 105a and a second RAN 105b (the system of RANs may include further RANs, not shown in FIG. 1).

The first RAN 105a comprises for example radio network nodes (e.g., NodeBs, eNodeBs, gNodeBs, depending on the generation of the wireless communication network), collectively denoted as 110a, belonging to a same RAT (e.g., a 3G RAT, a 4G RAT, a 5G RAT) and/or owned by a same, single network operator (Operator-1, or Operator-2, . . . , or Operator-N). The first RAN 105a also comprises radio network nodes (e.g., NodeBs, eNodeBs, gNodeBs), collectively denoted as 110b, belonging to different RATs and/or owned by two or more different network operators (e.g., any combination of two or more of the network operators Operator-1, or Operator-2, . . . , or Operator-N).

Similarly to the first RAN 105a, the second RAN 105b comprises for example radio network nodes (e.g., NodeBs, eNodeBs, gNodeBs), collectively denoted as 115a, belonging to a same RAT (e.g., a 3G RAT, a 4G RAT, a 5G RAT) and/or owned by a same, single network operator (Operator-1, or Operator-2, . . . , or Operator-N). The second RAN 105b also comprises radio network nodes (e.g., NodeBs, eNodeBs, gNodeBs), collectively denoted as 115b, belonging to different RATs and/or owned by two or more different network operators (e.g., any combination of two or more of the network operators Operator-1, or Operator-2, . . . , or Operator-N).

The radio network nodes 110a, 110b, 115a, 115b are Network Elements (NEs) of the wireless mobile telecommunications network.

The first RAN 105a is (i.e., the radio network nodes or NEs 110a and 110b of the first RAN 105a are) managed, for FCAPS purposes, by a first Element Manager (EM) 120a. Similarly, the second RAN 105b is (i.e., the radio network nodes or NEs 115a and 115b of the second RAN 105b are) managed, for FCAPS purposes, by a second EM 120b. The NEs of other RANs possibly part of the system of RANs, not shown in FIG. 1, are similarly managed, for FCAPS purposes, by respective, further EMs (not shown in FIG. 1).

The EMs 120a and 120b (and other EMs, if present) manage, for FCAPS purposes, the NEs under their responsibility and need to be managed and monitored by the telecommunications network operators in order to ensure the desired level of Quality of Service (QOS) to the network users. To this purpose, the EMs 120a and 120b (and other EMs, if present; in the following of this description reference will be made to the EMs 120a and 120b only, being intended that if other EMs are present, the same considerations apply also to them) expose two interfaces: a SouthBound Interface (SBI) towards the respective NEs under their responsibility (the radio network nodes 110a and 110b for the EM 120a; the radio network nodes 115a and 115b for the EM 120b), and a NorthBound Interface (NBI) 123 towards higher-level sub-systems of the wireless mobile telecommunications network.

The NBI of an EM conventionally allows direct communication between the EM and an Operational Support System (OSS) of a telecommunications network operator for enabling the OSS to perform operations concerning the NEs under the responsibility of the EM, particularly operations of Fault-management Configuration Accounting Performance and Security (FCAPS), such as Configuration Management (CM), Performance Management (PM), Trace Management (TM) and Fault Management (FM).

According to the example described herein, referring to a Multi-Operator RAN (MORAN) scenario, the NBIs of the EMs 120a and 120b allow the latter to communicate with different OSSs 130-1, 130-2, 130-N of the different network operators Operator-1, or Operator-2, . . . , or Operator-N. Each one of the OSSs 130-1, 130-2, 130-N includes systems/functions of the respective network operator for several operations concerning the NEs 110a, 110b, 115a and 115b, particularly FCAPS operations, such as Configuration Management (CM), Performance Management (PM), Trace Management (TM) and Fault Management (FM), as well as other operations, as described in detail later on.

According to the solution here disclosed, the NBIs 123 of all the EMs 120a and 120b are commonly attached to a same bus 125 and the communication with the different OSSs 130-1, 130-2, 130-N of the different network operators Operator-1, or Operator-2, . . . , or Operator-Nis mediated by an NBI mediator 135. The NBI mediator 135 (which is attached to the bus 125) is interposed between the NBIs 123 of the EMs 120a and 120b and the OSSs 130-1, 130-2, 130-N of the different network operators.

As mentioned a few lines above, the wireless telecommunications network scenario depicted in FIG. 1 and here considered by way of example is a MORAN scenario, in which different network operators Operator-1, Operator-2, . . . , Operator-N share, for the purposes of providing services to their subscribers, same NEs (at least some of all the NEs), i.e., same radio network nodes (NodeBs, eNodeBs, gNodeBs) of the NEs 110a, 110b, 115a and 115b. As mentioned in the foregoing, radio network nodes 110b of the first RAN 105a and radio network nodes 115b of the second RAN 105b may be shared, for the purposes of providing services to their subscribers, among different network operators.

Indeed, any of the radio network nodes 110a, 110b, 115a and 115b, despite possibly being shared among different network operators, is in practice owned by (i.e., belongs to the RAN physically deployed by) a specific one of the network operators Operator-1, Operator-2, . . . , Operator-N. Each network operator, despite sharing the use of its own radio network nodes with other network operators for the purposes of providing services to the users, needs to have a complete control of its own radio network nodes for the purpose of managing them. A unique OSS for all the EMs 120a and 120b communicating directly with them via their NBIs 123 is not suitable for allowing this, because from the one side that OSS would have access to all the data made available by the EMs 120a and 120b indiscriminately, and, from the other side, that OSS would be allowed to perform every management operation on the EMs 120a and 120b indiscriminately. The same problem arises if all the OSSs 130-1, 130-2, 130-N would directly communicate with the EMs 120a and 120b via their NBIs 123.

According to embodiments of the solution disclosed herein, the NBI mediator 135 is designed and configured to enable a partitioning of the system of RANs 105a, 105b which makes it possible for the different network operators Operator-1, Operator-2, . . . , Operator-N of the MORAN to exercise a complete control of their own RAN (i.e., of their own radio network nodes) for management purposes, while at the same time allowing a sharing of the RANs among the different network operators, for the purposes of providing services to the users. F

or management purposes of the RANs 105a, 105b of the system of RANs, the OSSs 130-1, 130-2, 130-N of the different network operators Operator-1, or Operator-2, . . . , or Operator-N interface with the NBI mediator 135 (in FIG. 1 the interactions between the OSSs of the different network operators Operator-1, or Operator-2, . . . , or Operator-N are denoted as 137-1a and 137-1b for OSS 130-1 of network operator Operator-1; 137-2 for the OSS 130-2 of network operator Operator-2, and 137-N for the OSS 130-N of network operator Operator-N). The OSSs 130-1, 130-2, 130-N interface with the NBI mediator 135 through an interface 139 which can be seen as a “filtered” version of the NBI 123 of the EMs 120a, 120b, where by “filtered” it is meant that the different OSSs 130-1, 130-2, 130-N of the different network operators Operator-1, Operator-2, . . . , Operator-N can only “see” those data exposed by the NBI 123 of the different EMs 120a, 120b which are of interest/pertinent to them.

The NBI mediator 135 is preferably programmable and contains the intelligence that allows segregating, for management purposes, the system of RANs 105a, 105b based on programmable logics, e.g., based on Filtering Parameters, globally denoted as 140 in FIG. 1. Such Filtering Parameters include for example, but are not limited to: univocal identifiers of the different PLMNs of the different network operators, E-UTRA Absolute Radio Frequency Channel Numbers (EARFCN, a code that for 4G FDD specifies a pair of physical radio carriers used for transmission and reception in a land mobile radio system, one for the uplink signal and one for the downlink signal), identifiers of the RATs available in the system of RANs, network cell name, network cell identifier, etc.

Also depicted in FIG. 1 is an Overall Network Administrator 145, which communicates, as denoted by reference numeral 147, with the EMs 120a, 120b directly (through the full NBI 123 exposed by the EMs), without the mediation of the NBI mediator 135, for purposes of supervising management of the EMs. The Overall Network Administrator 145 may be one of the different network operators Operator-1, Operator-2, . . . , Operator-N, or it can be a third-party entity, different from the network operators. The Overall Network Administrator 145 may for example set the Filtering Parameters 140 for the NBI mediator 135. The Overall Network Administrator 145 may also interface with the NBI mediator, as denoted by reference numeral 150 in FIG. 1, for application or system management (e.g., maintenance, software/firmware updates).

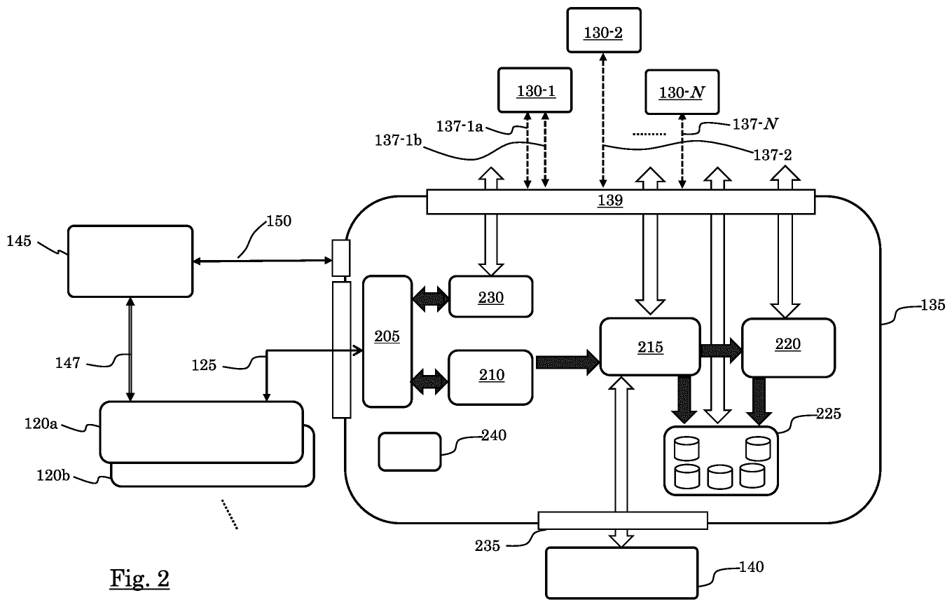

FIG. 2 shows in a certain detail, at the level of functional blocks/modules, the internal structure of the NBI mediator 135, in an embodiment of the solution disclosed herein.

The NBI mediator 135 comprises: an NBI termination functional module 205; an FCAPS mediator module 210; a Filtering capabilities module 215; an Encryption and ciphering module 220; a Data storage module 225, and a Configuration import adaptation module 230.

The NBI termination functional module 205 is configured to be able to manage different manufacturer-dependent NBIs (in fact, EMs of different manufacturers can implement and expose NBIs 123 which may differ, more or less slightly, from one another, e.g., in terms of data models: for example, the EM 120a and the EM 120b deployed on the field may be produced by different manufacturers, and their NBIs 123 may not be identical).

The FCAPS mediator module 210 implements an adaptation layer configured to ensure a proper conversion from the proprietary NBI data model of the NBIs 123 to a standard data model (either defined by standardization entities or defined by users, e.g., by the network operators Operator-1, Operator-2, . . . , Operator-N) in order to ensure that the EMs 120a, 120b expose a common interface towards the OSSs 130-1, 130-2, 130-N of the different network operators Operator-1, Operator-2, . . . , Operator-N.

Jointly, the NBI termination functional module 205 and the FCAPS mediator module 210 enable a consistent bi-directional communication between the EMs 120a and 120b and the OSSs 130-1, 130-2, 130-N of the different network operators Operator-1, Operator-2, . . . , Operator-N.

The Filtering capabilities module 215 is configured to implement the core functionality of the NBI mediator 135. The Filtering capabilities module 215 is configured to execute the filtering algorithm(s) that are used to “filter” the data exposed by the EMs 120a, 120b through their NBIs 123 and made available on the bus 125, to let the OSSs 130-1, 130-2, 130-N of the different network operators Operator-1, Operator-2, . . . , Operator-N access only those data of the different EMs 120a, 120b which are of interest/pertinent to them (for example, filtering on PLMN for 4G). The Filtering capabilities module 215 may expose an interface 235, for example an Application Programming Interface (API), that enables setting its configuration based on the Filtering Parameters 140 provided externally, e.g., by the Overall Network Administrator 145. The configuration of the Filtering capabilities module 215 may take place in real time and automatically. Through the interface 139 of the NBI mediator 135, the OSSs 130-1, 130-2, 130-N of the different network operators Operator-1, Operator-2, . . . , Operator-N may, in real-time, request and get from the Filtering capabilities module 215 the “filtered” data from the EMs 120a, 120b, which are derived from the data available on the bus 125 by segregating the part of the data of interest/pertinent to the specific OSS 130-1, 130-2, 130-N for management purposes. The Filtering capabilities module 215 also stores, in the Data storage module 225, the “filtered” data available on the bus 125, allowing the OSSs 130-1, 130-2, 130-N to access and retrieve the pertinent data off-line, at later times.

The Encryption and ciphering module 220 is configured to enable the activation of security mechanisms for storing and managing the data stored in the Data storage module 225 not in cleartext but protected, with higher security standards.

The Data storage module 225 is configured to enable the possibility, by the OSSs 130-1, 130-2, 130-N, to access the pertinent NEs management data off-line, with a predefined data historicization. The Data storage module 225 can be configured to store, in individual repositories, Configuration Management (CM) data, Performance Management (PM) data, Trace Management (TM) data, Fault Management (FM) data etc.

The Configuration import adaptation module 230 is configured to enable all the automation functionalities for the management (e.g., configuration) of the NEs (i.e., the radio network nodes 110a, 110b, 115a, 115b) by the competent OSS among the OSSs 130-1, 130-2, 130-N of the different network operators Operator-1, Operator-2, . . . , Operator-N. In particular, the Configuration import adaptation module 230 receives management (e.g., configuration) commands from the OSSs 130-1, 130-2, 130-N of the different network operators Operator-1, Operator-2, . . . , Operator-N and identifies which OSS can manage which NEs 110a, 110b, 115a, 115b of the system of RANs 105a, 105, by performing a check on the NE parameters that the OSS is trying to configure/modify (for example, to ensure that a certain OSS has the permission for configuring/changing the parameters of certain NEs belonging to a certain RAN) and address the management commands to the correct EM(s) 120a, 120b (which will then configure the proper NEs). In addition, also time scheduling of the configuration commands is possible.

The NBI mediator 135 may also include a Web Graphical User Interface (GUI) module 240 for allowing a system manager, e.g., of the Overall Network Administrator 140, manage the NBI mediator 135 through the Web.

Advantageously, all the data exchanges among the (functional modules of the) NBI mediator 135 and the OSSs are API based.

The NBI mediator 135, working on the NBI 123 of the EMs 120a, 120b, is useful also to meet security and automation aspects that are important and critical aspects of RAN. By means of programmable cloud-based microservices, enabling the OSSs of the different network operators to accomplish the management (e.g., FCAPS management or equivalent management functionalities) of their own portion of the RAN, the NBI mediator 135 can be used for several functionalities, such as those falling under FCAPS management: Configuration Management (CM) of the NEs, Performance Management (PM) of the NEs, Trace Management (TM) of the NEs, Fault Management (FM) of the NEs.

Advantageously, the NBI mediator 135 enables a fully automated filtering parameters change (e.g., by means of the API 235).

The NBI mediator 135 can also enable a fully automated network parameters change by means of the (APIs of the) configuration import adaptation module 230.

The NBI mediator 135 can also enable a periodical topology export, and/or a topology export based on request thanks to the API 139 that expose filtered topology. The EMs 120a, 120b make available to the network operators topological data describing the network of NEs under their responsibility. The NBI mediator 135 allows each network operator to access these topological data, filtered for the NEs owned by that network operator.

The NBI mediator 135 can also enable a fully automated configuration of Minimization of Drive Test (MDT) measurement campaigns selectively on the NEs or even network cells belonging to different network operators.

As mentioned, the NBI mediator 135 may advantageously enable encryption of the communication channel between the NBI mediator 135 and the OSSs 130-1, 130-2, 130-N of the different network operators Operator-1, Operator-2, . . . , Operator-N and of data exchanged with the OSSs of the different network operators, a backup of historical information, encryption and storage of CM/PM/FM/TM data (even for long storing times).

The NBI mediator 135 allows MOCN (Multi-Operator Core Network, a scenario in which a single network operator may have different core networks for, e.g., supporting private networks) management including filtering related to different core networks and/or radio access technologies. For example, the NBI mediator 135 allows a network operator to manage separately different RATs of the several possible RATs of the RANs 105a, 105b. This is schematically depicted in FIG. 1 and FIG. 2 by the two the interactions 137-1a and 137-1b between the OSS 130-1 of the network operator Operator-1: 137-1a denotes for example the filtered NBI visible to Operator-1 for one RAT of the RATs available in the system of RANs 120a, 120b, whereas 137-1b denotes the filtered NBI visible to Operator-1 for another RAT of the available RATs.

The NBI mediator 135 also allows managing Private Networks, with segregation of the management data.

The NBI mediator 135 allows an overall activity log tracing (keeping a log of all the activities performed by the different OSSs both on the NBI mediator 135 and on the NEs) for security purposes.

The network operators have the possibility to get near real-time data or offline data as needed. All the data exchanged with the network operators can be also provided with encryption on a ciphered channel.

Considering the flow from the EMs 120a, 120b to the OSSs 130-1, 130-2, . . . , 130-N, a possible example could be the daily topology generation: each EM daily prepares a topology with the description of the entire managed network (NEs, network cells, relationships of adjacency between network cells, etc . . . ) but each operator needs its own network topology in order to know the network status. For this reason, the NBI mediator 135 needs to filter the entire topology in order to expose through the interface 139 a part that is needed by the specific operator. This filtering operation is possible thanks to the NBI termination functional module 205, the FCAPS mediator module 210 and the Filtering capabilities module 215 that respectively terminate the interface, translate the topology in standard format and filter based on the defined filtering criteria. Based on the export, the operator could choose to change one or more parameters, e.g. one or more Physical Cell ID (PCI) to avoid PCI conflicts. In this case, through the interface 139, the Configuration import adaptation module 230 and the NBI termination functional module 205, the request of the operator is sent to the EM to change the PCI.

The Configuration import adaptation module 230 can also perform a check on the NE parameters that the OSS is trying to configure/modify in order to avoid that an operator changes parameters which impact other NE/operators. In addition, the request to update one or more parameters can be scheduled in time according to the most appropriate time; in the example of PCI above, the action should be scheduled in the night when the traffic of the network is in the lowest conditions.

The solution disclosed in this document can be applied in several scenarios, with the goal to create partitions of a wireless telecommunications network, which are manageable separately ensuring security and privacy needs.

The solution disclosed in this document is susceptible of being applied also to future evolution of the RAN, in which the FCAP management functionality will be accomplished, instead of by the Element Managers, by distributed partial services (“micro-services”), for example distributed among the Network Elements and the Operational Support System; the distributed partial services altogether implement FCAPS management functionalities. Therefore, FCAPS functionalities that, in current legacy networks are implemented by the EMs (“EM functionalities”) may, in future developments, be implemented by distributed micro-services, distributed among the NEs and the OSSs. Thus, for the purposes of the solution here disclosed, the expression “EM functionality” or “Network Element management functionality” is to be construed as meaning a functionality implemented by an EM, or an equivalent functionality implemented by a distributed micro-service, either in the NEs or in the OSSs.

1. A method of managing Network Elements of a system of access networks of a telecommunications network by one or more telecommunications operators through one or more Network Element management functionalities by Operational Support Systems of the telecommunications operators, the method comprising:
providing a mediator module configured for mediating the communications between the Operational Support Systems of the telecommunications operators and the Network Element management functionality by filtering said communications according to predetermined filtering criteria for allowing the Operational Support System of each of the one or more telecommunications operators to manage only a respective part of the Network Elements of the access network depending on said filtering criteria.

2. The method of claim 1, wherein said communications between the Operational Support Systems of the telecommunications operators and the Network Element management functionality are intended for Fault Configuration Accounting Performance and Security, FCAPS, management operations on said Network Elements.

3. The method of claim 1, wherein said Network Element management functionalities are implemented by Element Managers.

4. The method of claim 3, wherein the Element Managers expose a NorthBound interface and the mediator module is interposed between the NorthBound interface of the Element Managers and the Operational Support Systems of the telecommunications operators.

5. The method of claim 1, wherein said Network Element management functionalities are implemented by distributed partial services distributed among the Network Elements and the Operational Support Systems of the telecommunications operators, said distributed partial services altogether implementing the Network Element management functionalities.

6. A communications mediator:
designed to be interposed between a Network Element management functionality, responsible for the management of respective Network Elements of an access network system of a telecommunications system, and at least one Operational Support System of the at least one telecommunications operator of said telecommunications system, and
configured to mediate the communications between the Operational Support System and the Network Element management functionality by filtering said communications according to predetermined filtering criteria for allowing the Operational Support System to manage only a respective part of the Network Elements of the access network depending on said filtering criteria.

7. The communications mediator of claim 6, wherein said communications between the Operational Support Systems of the telecommunications operators and the Network Element management functionality are intended for Fault Configuration Accounting Performance and Security, FCAPS, management operations on said Network Elements.

8. The communications mediator of claim 6, wherein said Network Element management functionalities are implemented by Element Managers.

9. The communications mediator of claim 8, wherein the Element Managers expose a NorthBound interface and the mediator module is interposed between the NorthBound interface of the Element Managers and the Operational Support Systems of the telecommunications operators.

10. The communications mediator of claim 6, wherein said Network Element management functionalities are implemented by distributed partial services distributed among the Network Elements and the Operational Support Systems of the telecommunications operators, said distributed partial services altogether implementing the Network Element management functionalities.

11. The communications mediator of claim 6, comprising:
a communications filtering module configured to filter said communications between the Operational Support System and the Network Element management functionality according to said predetermined filtering criteria,
a programming interface configured to receive filtering parameters, defining said predetermined filtering criteria, for configuring said communications filtering module.

12. A telecommunications system comprising:
an access network system comprising a plurality of Network Elements;
one or more Network Element management functionalities, each one responsible for the management of a respective group of Network Elements of said plurality;
at least one Operational Support Systems of a respective at least one telecommunications operator, characterized by comprising:
a communications mediator according to claim 6, interposed between the Network Element management functionalities and the at least one Operational Support System of the at least one telecommunications operator, configured to mediate the communications between the Operational Support System and the Network Element management functionalities by filtering said communications according to predetermined filtering criteria for allowing the Operational Support System to manage only a respective part of the Network Elements of the access network depending on said filtering criteria.
